(19) United States
(12) Patent Application Publication
(10) Pub. No.: US 2026/0208054 A1
(43) Pub. Date: Jul. 23, 2026

(54) ATTACK METHOD AND APPARATUS FOR VIRTUAL WEAPON, STORAGE MEDIUM, AND COMPUTER DEVICE

(71) Applicant: NETEASE (HANGZHOU) NETWORK CO., LTD., Hangzhou, Zhejiang (CN)

(72) Inventors: Jiajun FAN, Hangzhou, Zhejiang (CN); Jifeng ZHENG, Hangzhou, Zhejiang (CN); Xiyu WANG, Hangzhou, Zhejiang (CN); Bincheng XU, Hangzhou, Zhejiang (CN)

(73) Assignee: NETEASE (HANGZHOU) NETWORK CO., LTD., Hangzhou, Zhejiang (CN)

(21) Appl. No.: 19/144,034

(22) PCT Filed: Jun. 1, 2023
(86) PCT No.: PCT/CN2023/097898

§ 371 Date: Jun. 27, 2025

(30) Foreign Application Priority Data
Dec. 27, 2022 (CN) 202211690791.6

(51) Int. Cl. A63F 13/837; A63F 13/533; A63F 13/55

(52) U.S. Cl. CPC A63F 13/837; A63F 13/533; A63F 13/55

(57) ABSTRACT

An attack method for the virtual weapon includes: displaying a graphical user interface which includes a virtual scene, a target virtual vehicle configured with virtual weapons at different weapon orientations, a first-type attack control, and second-type attack controls, wherein the second-type attack controls are arranged at different control orientations relative to the first-type attack control; when there is a target to be attacked within an attack range of a first target virtual weapon, determining a first target attack control from the second-type attack controls, a control orientation of which corresponds to a first target weapon orientation of the first target virtual weapon; updating an initial display mode of the first target attack control to a first display effect style; and in response to a first control operation on the first target attack control, controlling the first target virtual weapon to launch a second-type attack on said target.

### CROSS REFERENCE TO RELATED APPLICATIONS

The present disclosure is a U.S. national phase application of International Application No. PCT/CN2023/097898, filed on Jun. 1, 2023, which is based upon and claims priority to Chinese Patent Application No. 202211690791.6, filed on Dec. 27, 2022 and entitled “ATTACK METHOD AND APPARATUS FOR VIRTUAL WEAPON, STORAGE MEDIUM, AND COMPUTER DEVICE”, the entire contents of which are incorporated herein by reference.

### TECHNICAL FIELD

The present disclosure relates to the field of computer technology, in particular to an attack method and an apparatus for a virtual weapon, a storage medium, and a computer device.

### BACKGROUND

In recent years, with the development and popularization of computer device technology, many navigation themed games have emerged, in which modules for maritime battles are usually provided. In the game, many ships are equipped with virtual weapons at multiple positions, such as a front gun, a left-front gun, a right-front gun, or a left-rear gun, etc.

In the related art, there are always modules for maritime battles in many navigation themed mobile games. However, for mobile games, because an input way using only two fingers is adopted, it becomes very difficult to add different ways of maritime battles to ships that need to navigate. Therefore, many navigation themed mobile games currently have very simple battle modes, attacking through ships as a whole.

### SUMMARY

In a first aspect, an attack method for a virtual weapon is provided, including:
displaying a graphical user interface, wherein the graphical user interface includes at least a portion of a virtual scene, a target virtual vehicle, a first-type attack control, and second-type attack controls displayed in an initial display mode, which are located in the virtual scene, virtual weapons are configured at different weapon orientations on the target virtual vehicle, and the second-type attack controls are disposed at different control orientations relative to the first-type attack control, with the control orientation of each second-type attack control and the weapon orientation of each virtual weapon being in correspondence;
in the case that a target to be attacked exists within an attack range of a first target virtual weapon in the virtual weapons, determining, based on the correspondence between the control orientation and the weapon orientation, a first target attack control from the second-type attack controls whose control orientation corresponds to a first target weapon orientation of the first target virtual weapon;
controlling to update the initial display mode of the first target attack control from the second-type attack controls to a first display effect style for display, wherein the first display effect style is different from the initial display mode;
controlling, in response to a first control operation on the first target attack control from the second-type attack controls, the first target virtual weapon to perform a second-type attack on the target to be attacked.

In a second aspect, a computer-readable storage medium have multiple instructions stored thereon is provided. When the multiple instructions are loaded by a processor, cause the processor to perform the attack method for the virtual weapon as described above.

In a third aspect, a computer device is provided, including a memory, a processor, and a computer program stored on the memory and executable on the processor; wherein the processor is configured to execute the computer program to perform the attack method for the virtual weapon as described above.

### BRIEF DESCRIPTION OF THE DRAWINGS

In order to more clearly describe technical solutions in embodiments of the present disclosure, drawings required in embodiments will be introduced briefly in the following. It is apparent that the drawings in the following are only some embodiments of the present disclosure. For those of ordinary skill in the art, other related drawings can also be obtained according to these drawings without any creative efforts.

FIG. 1a is a schematic diagram of a system to which an attack method for a virtual weapon is applied according to one or more embodiments of the present disclosure.

FIG. 1b is a flowchart of an attack method for a virtual weapon according to one or more embodiments of the present disclosure.

FIG. 1c is a schematic diagram of a graphical user interface according to one or more embodiments of the present disclosure.

FIG. 1d is a schematic diagram of a graphical user interface according to one or more embodiments of the present disclosure.

FIG. 1e is a schematic diagram of a graphical user interface according to one or more embodiments of the present disclosure.

FIG. 1f is a schematic diagram of a graphical user interface according to one or more embodiments of the present disclosure.

FIG. 1g is a schematic diagram of a graphical user interface according to one or more embodiments of the present disclosure.

FIG. 1h is a schematic diagram of a graphical user interface according to one or more embodiments of the present disclosure.

FIG. 2 is a schematic diagram of a structure of an attack apparatus for a virtual weapon according to one or more embodiments of the present disclosure.

FIG. 3 is a schematic diagram of a structure of a computer device according to one or more embodiments of the present disclosure.

### DETAILED DESCRIPTION

Technical solutions in embodiments of the present disclosure will be described clearly and completely below with reference to the drawings for embodiments of the present disclosure. Obviously, embodiments described herein are some, but not all, embodiments of the present disclosure. All other embodiments obtained based on embodiments in the present disclosure, by those of ordinary skill in the art without any creative efforts, fall in the scope of the present disclosure.

Embodiments of the present disclosure provide an attack method for a virtual weapon, an attack apparatus for a virtual weapon, a storage medium, and a computer device. In some embodiments, the attack method for the virtual weapon disclosed by the present disclosure can be performed by a computer device. The computer device can be a terminal or a server. The terminal can be a terminal device such as a smartphone, a tablet, a laptop, a touch screen, a game console, a personal computer (PC), a personal digital assistant (PDA), etc. The terminal device can also include a client, which can be a game application client, a browser client carrying game programs, or an instant messaging client, etc. The server can be an independent physical server, a cluster of multiple physical servers, or a distributed system. The server can also be a cloud server that can provide cloud services, cloud databases, cloud computing, cloud functions, cloud storage, network services, cloud communication, middleware services, domain name services, security services, CDN, and basic cloud computing services such as big data and artificial intelligence platforms.

In some embodiments, when the attack method for the virtual weapon runs on the terminal device which stores the game application, the terminal device presents some game scenes through display components. The terminal device is used to interact with users through a graphical user interface, for example, the terminal device is used to download, install, and run the game application. The terminal device can provide the graphical user interface to users in various ways, such as displaying images on the terminal device's screen through rendering, or presenting the graphical user interface through holographic projection. For example, terminal devices can include a touch screen and a processor. The touch screen is used to present the graphical user interface and receive operation instructions generated based on the user input in the graphical user interface. The graphical user interface includes game screens, and the processor is used to run the game, generate the graphical user interface, respond to the operation instructions, and control the display of the graphical user interface on the touch screen.

In some embodiments, when the attack method for the virtual weapon runs on the server, the game can be cloud games. The cloud game refers to a gaming style based on cloud computing. In the running mode of cloud games, the main body on which the game application programs run and the main body on which the game screens is rendered are separated. The attack method for the virtual weapon is stored and operated on the cloud game server. The presentation of game screens is completed on the cloud game client. The cloud game client is mainly used for receiving and sending game data as well as presenting game screens. For example, the cloud game client can be a display device with a data transmission function disposed close to the user's side, such as mobile terminals, televisions, computers, handheld computers, personal digital assistants, etc. However, the terminal device used for achieving the attack using the virtual weapon is the cloud game server in the cloud. When playing a game, the user operates the cloud game client to send operation instructions to the cloud game server. The cloud game server runs the game according to the operation instructions, encodes and compresses the game screens and other data, returns them to the cloud game client through the network, and finally decodes and outputs the game screens through the cloud game client.

As shown in FIG. la, a schematic diagram of a system to which an attack method for a virtual weapon is applied according to one or more embodiments of the present disclosure is provided. The system can include at least one computer device 1000, at least one server 2000, at least one database 3000, and a network 4000. The computer device 1000 is held by a user, and can be connected to servers of different games through the network 4000. The computer device 1000 is any device with computing hardware capable of supporting and executing software products corresponding to the games. In addition, computer device 1000 has one or more multi-touch sensitive screens for sensing and obtaining user inputs through touch or slide operations performed at multiple points on one or more touch screens. In addition, when the system includes multiple computer devices 1000, multiple servers 2000, and multiple networks 4000, different computer devices 1000 can be connected to each other through different networks 4000 and different servers 2000. The network 4000 can be a wireless network or a wired network. The wireless network is, for example, a wireless local area network (WLAN), a local area network (LAN), a cellular network, a 2G network, a 3G network, a 4G network, a 5G network, etc. In addition, different computer devices 1000 can also use their own Bluetooth network or hotspot network to connect to other terminals or servers. For example, multiple users can be online through different computer devices 1000 and can be connected and synchronized to each other through appropriate networks, to support multi-user gaming. In addition, the system can include multiple databases 3000, which are coupled to different servers 2000, and can continuously store information related to the game environment in the database 3000 when different users are participated in the multi-user gaming online.

Embodiments of the present disclosure provide an attack method for a virtual weapon, which can be performed by a terminal or a server. Embodiments of the present disclosure will be described using that the attack method for the virtual weapon is performed by a terminal as an example. The terminal includes a display component and a processor, and the display component is used to present a graphical user interface and receive operation instructions generated by the user acting on the display component. When users operate the graphical user interface through the display component, the graphical user interface can control the local contents in the terminal in response to received operation instructions, or control the contents in the server on an opposite side in response to received operation instructions. For example, the operation instructions generated by the user acting on the graphical user interface include instructions for launching the game application, and the processor is configured to launch the game application upon receiving the instructions provided by the user to launch the game application. In addition, the processor is configured to render and depict the graphical user interface associated with the game on the touch screen. The touch screen is a multi-touch sensitive screen that can sense touch or slide operations performed simultaneously at multiple points on the screen. The user performs touch operations on the graphical user interface using her/his fingers. When detecting the touch operations, the graphical user interface controls different virtual objects in the graphical user interface of the game to perform actions corresponding to the touch operations. For example, the game can be any of casual games, action games, role-playing games, strategy games, sports games, puzzle games, first person shooting games (FPS), etc. The game can include virtual game scenes depicted on the graphical user interface. In addition, the virtual game scene can include one or more virtual objects controlled by the user (or users), such as virtual characters. In addition, the virtual game scene can also include one or more obstacles, such as railings, ravines, walls, etc., to restrict the movement of virtual objects. For example, the obstacles restrict the movement of one or more objects to a specific area within the virtual scene. In some embodiments, the virtual game scene also includes one or more elements, such as skills, scores, character health status, energy, etc., to provide assistance and offer virtual services to users, and to increase scores related to user performance, etc. In addition, the graphical user interface can also present one or more indicators to provide instructional information to the user. For example, the game can include a virtual object controlled by the user and one or more other virtual objects (such as enemy characters). In some embodiments, the one or more other virtual objects are controlled by other users in the game. For example, the one or more other virtual objects can be controlled by a computer, such as a robot using artificial intelligence (AI) algorithms, to achieve a human-machine battle mode. For example, the virtual object possesses various skills or capacities that user uses to achieve her/his goals in the game. For example, the virtual object possesses one or more weapons, props, tools, etc. that can be used to eliminate other objects from the game. Such skills or capacities can be activated by the user by using one of multiple preset touch operations on the terminal's touch screen. The processor can be configured to present corresponding game screens in response to the operation instructions generated based on the user touch operations.

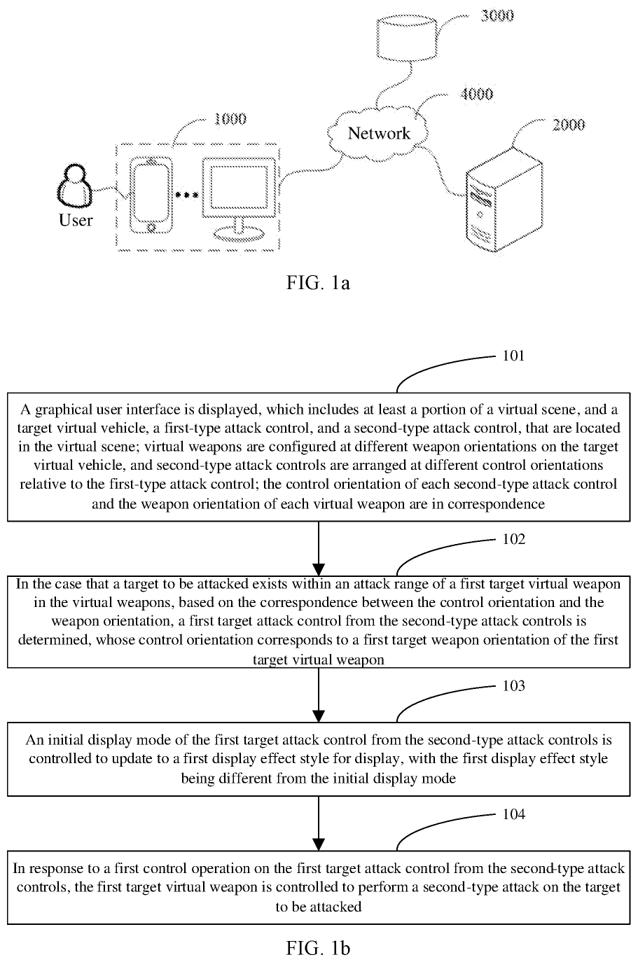

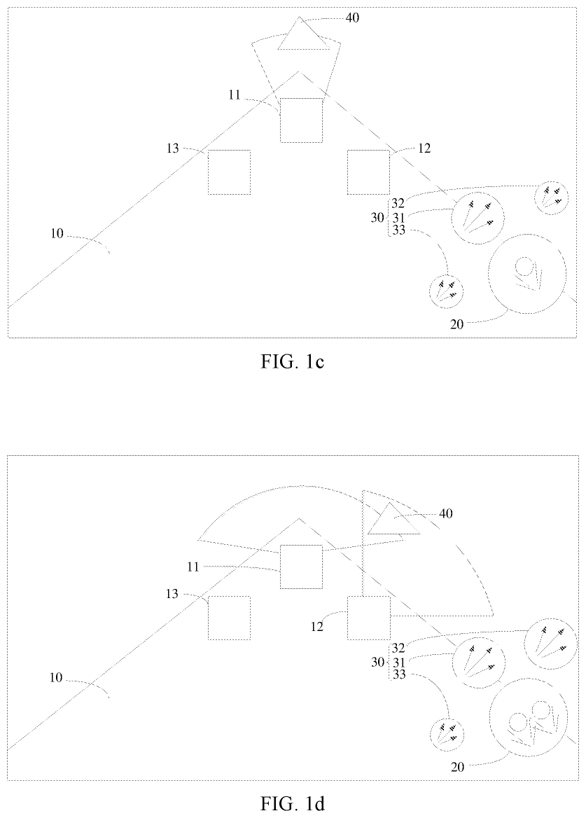

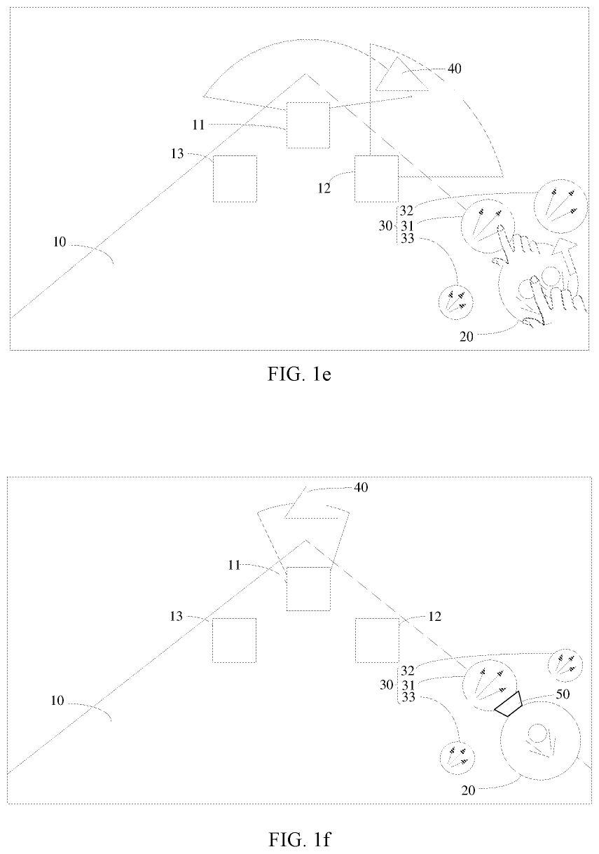

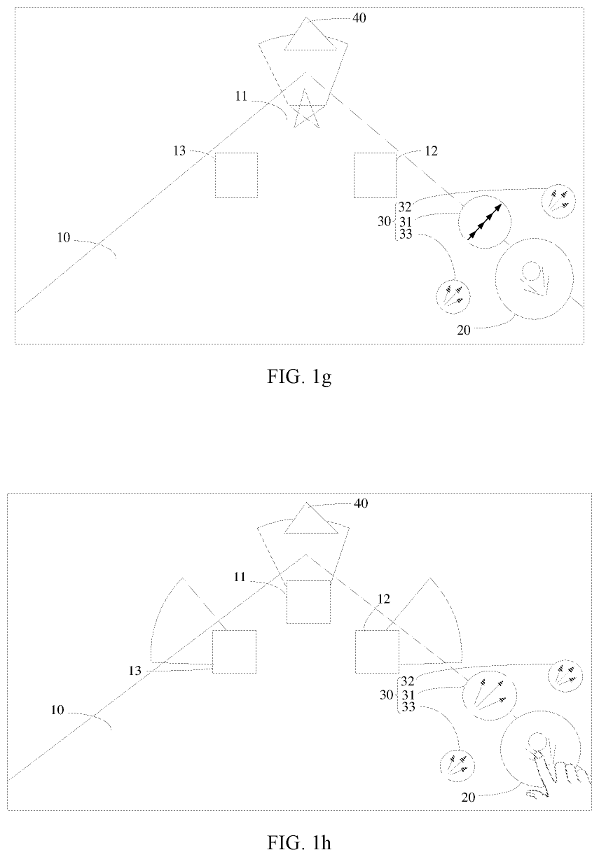

It should be noted that the system shown in the schematic diagram in FIG. 1a is only an example. The system to which the attack method for the virtual weapon is applied and the scenes described in embodiments of the present disclosure are for the purpose of providing a clearer explanation of the technical solutions in embodiments of the present disclosure, and do not constitute a limitation on the technical solutions in embodiments of the present disclosure. Those skilled in the art know that with the evolution of the system and the emergence of new business scenes, the technical solutions provided in embodiments of the present disclosure are also applicable to similar technical problems.

In some embodiments, the description will be made from the perspective of an attack apparatus for a virtual weapon, which can be specifically integrated into a computer device having storage units, the microprocessor, and the computing capability.

As shown in FIG. 1b, a flowchart of an attack method for a virtual weapon according to one or more embodiments of the present disclosure is provided. The attack method for the virtual weapon includes following steps.

In step 101, a graphical user interface is displayed, which includes at least a portion of a virtual scene, and a target virtual vehicle, a first-type attack control, and a second-type attack control, that are located in the virtual scene. Virtual weapons are configured at different weapon orientations on the target virtual vehicle, and second-type attack controls are arranged at different control orientations relative to the first-type attack control. The control orientation of each second-type attack control and the weapon orientation of each virtual weapon are in correspondence.

In some embodiments, the graphical user interface displays a three-dimensional virtual scene in the game scene. The three-dimensional virtual scene is a virtual scene provided by the application when the application is running on the terminal, which can be a simulated scene of the real world, a semi simulated and semi fictional scene, or a purely fictional scene. The scene displayed in the graphical user interface is a scene screen presented when a virtual object observes in the three-dimensional virtual scene. The user can manipulate the virtual object in the game scene through the terminal, and observe the three-dimensional virtual scene through a camera model. Taking the FPS game as an example, when in the first person perspective, the camera model is located at the head or neck of the target virtual object, and only an arm part of the virtual character can be displayed in the graphical user interface. When in the third person perspective, the camera model is located behind the target virtual object, and only the upper body of the virtual character can be displayed in the graphical user interface. The graphical user interface is the scene screen presented by observing the three-dimensional virtual scene from a certain perspective through the camera model.

As shown in FIG. 1c, a schematic diagram of a graphical user interface according to one or more embodiments of the present disclosure is provided. The graphical user interface is displayed on the screen of computer device 1000, which includes at least a portion of the virtual scene captured by the camera model, as well as a target virtual vehicle 10, a first-type attack control 20, and a second-type attack control 30, that are located in the virtual scene. In some embodiments, virtual weapons are configured at different weapon orientations of the target virtual vehicle 10, such as a virtual weapon 11 (front gun), a virtual weapon 12 (right-front gun), and a virtual weapon 13 (left-front gun) in FIG. 1c. The virtual weapon 11 is configured in front of the target virtual vehicle 10, the virtual weapon 12 is configured in front of the target virtual vehicle 10 on the right, and the virtual weapon 13 is configured in front of the target virtual vehicle 10 on the left. The weapon orientations are the front, the right-front, and the left-front.

In some embodiments, the second-type attack controls 30 are disposed at different control orientations of the first-type attack control 20, and the control orientation of each of the second-type attack controls corresponds to the weapon orientation of each of the virtual weapons. As shown in FIG. 1c, taking the first-type attack control 20 as an example, a left side facing upwards by 45 degrees of the first-type attack control 20 is as the front, the second-type attack control 31 is disposed in left-front of the first-type attack control 20, the second-type attack control 32 is disposed in right-front of the first-type attack control 20, and the second-type attack controls 33 are disposed in left-front of the first-type attack control 20 (the front, the right-front, and the left-front are the control orientations), respectively corresponding to the front, the right-front, and the left-front in the weapon orientations, so that the second-type attack control 31 corresponds to the virtual weapon 11, the second-type attack control 32 corresponds to the virtual weapon 12, and the second-type attack control 33 corresponds to the virtual weapon 13.

It can be understood that the user graphical interface not only includes the above-mentioned controls, but also other functional controls or identifiers, depending on the specific game contents, which is not limited herein.

In step 102, in the case that a target to be attacked exists within an attack range of a first target virtual weapon in the virtual weapons, based on the correspondence between the control orientation and the weapon orientation, a first target attack control from the second-type attack controls is determined, whose control orientation corresponds to a first target weapon orientation of the first target virtual weapon.

In some embodiments, the first target virtual weapon refers to the virtual weapon in the virtual weapons whose attack range contains a target to be attacked. The second-type attack control corresponding to the first target virtual weapon can be determined based on the correspondence between the control orientation and the weapon orientation.

In some embodiments, if the first target virtual weapon is the virtual weapon 11, and its weapon orientation is the “front”, then the first target attack control from the second-type attack controls is the second-type attack control 31, with the control orientation of the first target attack control relative to the control orientation of the first-type attack control being the front.

In step 103, an initial display mode of the first target attack control from the second-type attack controls is controlled to update to a first display effect style for display, with the first display effect style being different from the initial display mode.

In some embodiments, as shown in FIG. 1c, in order to enable the user to know through the second-type attack control, within the attack range of which virtual weapon the target to be attacked exists, the first target attack control from the second-type attack controls corresponding to the first target virtual weapon, within the attack range of which the target to be attacked exists, can be displayed in the first display effect style (for example, the second-type attack control 31 in FIG. 1c is displayed in the highlighted effect style), while other second-type attack control(s), except for the first target attack control, from the second-type attack controls, is/are displayed in a second display effect style that is different from the first display effect style (for example, the second-type attack control 32 and the second-type attack control 33 in FIG. 1c are displayed in the extinguishing effect style).

In step 104, in response to a first control operation on the first target attack control from the second-type attack controls, the first target virtual weapon is controlled to perform a second-type attack on the target to be attacked.

In some embodiments, an attack mode of the virtual weapon can be divided into two types: a normal attack and a skill attack. The first-type attack is the normal attack, and the second-type attack is the skill attack. The first-type attack control is the attack control for the normal attack, and the second-type attack control is the attack control for the skill attack.

If the user performs the first control operation on the first target attack control from the second-type attack controls, the first target virtual weapon corresponding to the first target attack control is controlled to perform the second-type attack on the target to be attacked, that is, the first target virtual weapon is controlled to perform the skill attack on the target to be attacked.

In some embodiments, the method further includes following steps.

In response to a second control operation on the first-type attack control, the first target virtual weapon is controlled to perform the first-type attack on the target to be attacked.

In some embodiments, if the user performs the second control operation on the first-type attack control, the first target virtual weapon is controlled to perform the first-type attack on the target to be attacked, that is, the first target virtual weapon is controlled to perform the normal attack on the target to be attacked.

In some embodiments, prior to the step of controlling the first target virtual weapon to perform the first-type attack on the target to be attacked in response to the second control operation on the first-type attack control, the method further includes following steps.

In the case that the target to be attacked exists within the attack range of the first target virtual weapon in the virtual weapons, a mapping relationship between the control orientation of the first-type attack control and the first target weapon orientation is established.

In some embodiments, the step of controlling the first target virtual weapon to perform the first-type attack on the target to be attacked in response to the second control operation on the first-type attack control includes following steps.
(1) In response to the second control operation on the first-type attack control, the first target weapon orientation that has the mapping relationship with the first-type attack control is determined.
(2) The first target virtual weapon configured at the first target weapon orientation is determined, and the first target virtual weapon is controlled to perform the first-type attack on the target to be attacked.

In some embodiments, for the case where there is a target to be attacked within the attack range of the first target virtual weapon, the user's second control operation on the first-type attack control is to trigger the first target virtual weapon to perform the first-type attack on the target to be attacked. Moreover, every time the user performs the second control operation on the first-type attack control, the first target virtual weapon may change. For example, the first target virtual weapon for the previous time is the front gun, and the first target virtual weapon for the present time is the left-front and right-front guns. Therefore, in order to achieve the first-type attack performed by the corresponding first target virtual weapon is controlled every time through the second control operation on the first-type attack control, it is necessary to establish, in responsive to the second control operation on the first-type attack control, and before controlling the first target virtual weapon to perform the first-type attack on the target to be attacked, the mapping relationship between the first-type attack control and the first target weapon orientation when there is a target to be attacked within the attack range of the first target virtual weapon in the virtual weapons. As a result, the first target weapon orientation that was previously mapped to the first-type attack control can be determined in responsive to the second control operation on the first-type attack control, the first target virtual weapon configured at the first target weapon orientation is determined based on the first target weapon orientation, and the first target virtual weapon is controlled to perform the first-type attack on the target to be attacked, where the number of the first target virtual weapons can be one or more.

For example, when the number of first target virtual weapons is two, and when the first target virtual weapons are the left-front gun and the right-front gun, the first target weapon orientation is the left-front and the right-front, and the mapping relationship between the left-front as well as the right-front and the first-type attack control is established (the left-front and the right-front can be used as a set of first target weapon orientations to establish a mapping relationship with the first-type attack control, or a mapping relationship between the left-front and the first-type attack control, and a mapping relationship between the right-front and the first-type attack control, can be established separately, that is, the mapping relationships can be established twice, and the specific way of establishing the mapping relationship is not limited herein), so that in response to the second control operation on the first-type attack control, the first target weapon orientation that has a mapping relationship with the first-type attack control is determined as the left-front and the right-front, and the first target virtual weapons configured in the left-front and the right-front are determined as the left-front gun and the right-front gun. Then the left-front gun and the right-front gun are controlled to perform the first-type attack on the target to be attacked.

In some embodiments, the first-type attack control includes multiple first control icon styles, and the first control icon styles include virtual weapon identifiers with a different displayed number.

Before the step of controlling the first target virtual weapon to perform the first-type attack on the target to be attacked in response to the second control operation on the first-type attack control, the method further includes following steps.
(1) A number of the first target virtual weapons is determined.
(2) Based on correspondence between a number of virtual weapons and a displayed number, a target first control icon style is determined from multiple first control icon styles.
(3) The first-type attack control is displayed in the target first control icon style.

As shown in FIG. 1d, a schematic diagram of a graphical user interface according to one or more embodiments of the present disclosure is provided. In order to enable the user to know how many first target virtual weapons simultaneously have targets to be attacked existed within their attack ranges, the virtual weapon identifier with corresponding displayed number can be displayed in the first-type attack control to inform the user of the number of the first target virtual weapons.

In some embodiments, the first-type attack control includes multiple first control icon styles, each of which includes a virtual weapon identifier with a different displayed number. Before controlling the first target virtual weapon to perform the first-type attack on the target to be attacked in response to the second control operation on the first-type attack control, the number of the first target virtual weapons can be determined. Based on the correspondence between the number of the first target virtual weapons and the displayed number, the target first control icon style can be determined from the multiple first control icon styles. The first-type attack control is then displayed in the target first control icon style.

For example, as shown in FIG. 1d, if the target to be attacked is simultaneously within the attack ranges of the virtual weapon 11 and the virtual weapon 12, it indicates that the first target virtual weapons at the moment are two virtual weapons (the virtual weapon 11 and the virtual weapon 12). Therefore, the first control icon style for the first-type attack control 20 includes a virtual weapon identifier with two virtual weapons displayed. In some embodiments, the target to be attacked can be multiple and located within the attack ranges of different virtual weapons, which is not limited herein.

In some embodiments, the method further includes following steps.
(1) In response to a third control operation starting from the first-type attack control and ending at the first target attack control from the second-type attack controls, a number of the first target virtual weapons is determined.
(2) In response to the number of the first target virtual weapons being one, the first target virtual weapon is controlled to perform a first-type attack and a second-type attack on the target to be attacked.

As shown in FIG. 1e, a schematic diagram of a graphical user interface according to one or more embodiments of the present disclosure is provided. When a user performs the third control operation starting from the first-type attack control and ending at the first target attack control from the second-type attack controls on the first-type attack control and the second-type attack control, the number of the first target virtual weapons is determined. If there is only one first target virtual weapon, the first target virtual weapon is controlled to simultaneously perform the first-type attack and the second-type attack on the target to be attacked.

In some embodiments, the third control operation can be a sliding operation, starting from the first-type attack control and ending at the first target attack control from the second-type attack controls, that is, sliding from the first-type attack control to the first target attack control. The third control operation can also be a click operation, starting from the first-type attack control and ending at the first target attack control from the second-type attack controls, that is, first clicking on the first-type attack control and then clicking on the first target attack control within a preset time period.

In some embodiments, the method further includes following steps.
(1) In response to the number of the first target virtual weapons being not one, a designated first target attack control, on which the third control operation is applied, is determined among the first target attack control from the second-type attack controls.
(2) Based on the correspondence between the control orientation and the weapon orientation, a designated first target virtual weapon whose weapon orientation corresponds to a designated target control orientation of the designated first target attack control from the second-type attack controls is determined.
(3) The designated first target virtual weapon is controlled to perform a first-type attack and a second-type attack on the target to be attacked.

In some embodiments, in response to the number of the first target virtual weapons being not one, the designated first target attack control from the second-type attack controls, on which the third control operation is applied, is determined. Based on the correspondence between the control orientation and the weapon orientation, the designated first target virtual weapon whose weapon orientation corresponds to the designated target control orientation of the designated first target attack control is determined, thereby controlling the designated first target virtual weapon to perform the first-type attack and the second-type attack on the target to be attacked.

For example, as shown in FIG. 1e, if the target 40 to be attacked exists within the attack ranges of both virtual weapon 11 and virtual weapon 12, then the number of the first target virtual weapons is two. At the moment, both the second-type attack control 31 and the second-type attack control 32 are in the first display mode. The user's third control operation starts from the first-type attack control 20 and ends at the second-type attack control 31. Therefore, the designated first target attack control from the second-type attack controls, on which the third control operation is applied, is the second-type attack control 31. Based on the correspondence between the control orientation and the weapon orientation, the designated first target virtual weapon corresponding to the designated target control orientation of the designated first target attack control is the virtual weapon 11, whose weapon orientation corresponds to the designated target control orientation. Then, the virtual weapon 11 is controlled to simultaneously perform the first-type attack and the second-type attack on target 40.

In some embodiments, the method further includes following steps.

The first target virtual weapon is controlled to perform the first-type attack on the target to be attacked, and the designated first target virtual weapon is controlled to perform the second-type attack on the target to be attacked.

In some embodiments, when the number of the first target virtual weapons is not one, the third control operation can also be used to control the first target virtual weapon to perform the first-type attack on the target to be attacked, and to control the designated first target virtual weapon to perform the second-type attack on the target to be attacked.

For example, as shown in FIG. 1e, the virtual weapon 11 and the virtual weapon 12 are controlled to perform the first-type attack on the target 40, and the virtual weapon 11 is controlled to perform the second-type attack on the target 40.

In some embodiments, an outer edge of the first-type attack control is provided with a viewpoint orientation identifier, and the method further includes following steps.
(1) A current viewpoint orientation is obtained and a second target virtual weapon within the current viewpoint orientation is determined.
(2) Based on the correspondence between the control orientation and the weapon orientation, a second target attack control from the second-type attack controls whose control orientation corresponds to a second target weapon orientation of the second target virtual weapon is determined.
(3) The viewpoint orientation identifier is controlled to point towards the second target attack control from the second-type attack controls.

In some embodiments, in order to provide a more intuitive connection between the current viewpoint orientation and the virtual weapon, a content for mapping the viewpoint orientation has also been added to the first-type attack control. The outer edge of the first-type attack control is provided with the viewpoint orientation identifier, and the viewpoint orientation identifier can slide on the outer edge of the first-type attack control 20, to make the viewpoint orientation identifier face towards different directions. As shown in FIG. If, a schematic diagram of a graphical user interface according to one or more embodiments of the present disclosure is provided. An orientation of a current perspective of the virtual character controlled by the user is obtained, and the second target virtual weapon within the orientation of the current perspective is determined. Based on the correspondence between the control orientation and the weapon orientation, the second target attack control from the second-type attack controls whose control orientation corresponds to the second target weapon orientation of the second target virtual weapon is determined. The viewpoint orientation identifier is then controlled to point towards the second target attack control.

For example, as shown in FIG. 1f, the second target virtual weapon within the orientation of the current perspective is the virtual weapon 11. Based on the correspondence between the control orientation and the weapon orientation, the second target attack control from the second-type attack controls corresponding to the virtual weapon 11 is determined to be the second-type attack control 31. Then, the viewpoint orientation identifier 50 is controlled to point towards the second-type attack control 31.

In some implementations, the virtual weapon includes multiple weapon types, and the second control icon style of each of the second-type attack controls corresponds to the weapon type of the corresponding virtual weapon.

In some embodiments, in order to enrich the gameplay of the game, different types of virtual weapons can be disposed on the target virtual vehicle. In order to enable the user to clearly know the weapon types of virtual weapons disposed in different weapon orientations, the second control icon style of the second-type attack control corresponding to each virtual weapon can be matched with the weapon type of the corresponding virtual weapon.

As shown in FIG. 1g, a schematic diagram of a graphical user interface according to one or more embodiments of the present disclosure is provided. The weapon type of the virtual weapon 11 is a machine gun, while the weapon types of virtual weapons 12 and 13 are artilleries. The second control icon style of the second-type attack control 31 corresponding to virtual weapon 11 is multiple arrows pointing in the same direction, while the second control icon styles of the second-type attack controls 32 and 33 corresponding to virtual weapons 12 and 13 are multiple arrows pointing in different directions.

In some embodiments, the method further includes following steps.

In the case that no target to be attacked exists within the attack range of each virtual weapon, in response to a third control operation on the first-type attack control, the attack range corresponding to each virtual weapon is displayed in the graphical user interface.

In some embodiments, as shown in FIG. 1h, a schematic diagram of a graphical user interface according to one or more embodiments of the present disclosure is provided. When there is no target to be attacked within the attack range of any of the virtual weapons, if the user performs the third control operation on the first-type attack control 20 at the moment, the attack range corresponding to each virtual weapon will be displayed in the graphical user interface, such as the fan-shaped areas corresponding to virtual weapon 11, virtual weapon 12, and virtual weapon 13 in FIG. 1h.

As can be seen from the above, according to embodiments of the present disclosure, a graphical user interface is displayed, which includes at least a portion of a virtual scene, and a target virtual vehicle, a first-type attack control, and a second-type attack control displayed in an initial display mode, that are located in the virtual scene. Virtual weapons are configured at different weapon orientations on the target virtual vehicle, and second-type attack controls are disposed at different control orientations relative to the first-type attack control. The control orientation of each second-type attack control and the weapon orientation of each virtual weapon are in correspondence. When there is a target to be attacked within an attack range of a first target virtual weapon in the virtual weapons, based on the correspondence between the control orientation and the weapon orientation, a first target attack control from the second-type attack controls is determined, whose control orientation corresponds to the first target weapon orientation of the first target virtual weapon. The initial display mode of the first target attack control is controlled to update to a first display effect style for display, with the first display effect style being different from the initial display mode. In response to a first control operation on the first target attack control, the first target virtual weapon is controlled to perform a second-type attack on the target to be attacked. As a result, through the control operation on the second-type attack control from the user, it is possible to independently control one or more virtual weapons in the ship to perform an attack, thereby improving the simulated reality in the game when the user is playing.

In order to facilitate better implementation of the attack methods for the virtual weapon provided by the present disclosure, embodiments of the present disclosure also provide an apparatus based on the attack method for the virtual weapon described above. The meaning of the words is the same as that in the attack methods for the virtual weapon mentioned above. For specific implementation details, reference can be made to the method embodiments of the present disclosure.

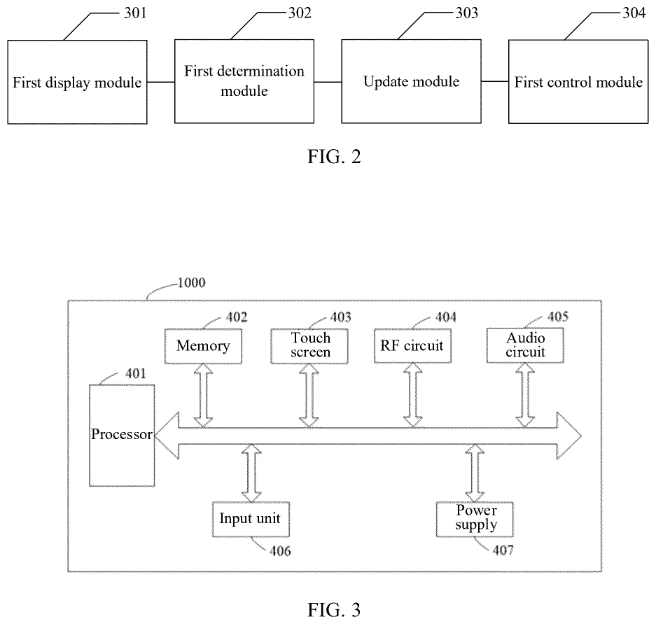

As shown in FIG. 2, a schematic diagram of a structure of an attack apparatus for a virtual weapon according to one or more embodiments of the present disclosure is provided. The attack apparatus for the virtual weapon can include a first display module 301, a first determination module 302, an update module 303, and a first control module 304.

The first display module 301 is configured to display a graphical user interface, the graphical user interface includes at least a portion of a virtual scene, a target virtual vehicle, a first-type attack control, and second-type attack controls displayed in an initial display mode, which are located in the virtual scene, virtual weapons are configured at different weapon orientations on the target virtual vehicle, and the second-type attack controls are disposed at different control orientations relative to the first-type attack control, with the control orientation of each second-type attack control and the weapon orientation of each virtual weapon being in correspondence.

The first determination module 302 is configured to determine, when a target to be attacked exists within an attack range of a first target virtual weapon in the virtual weapons, a first target attack control from the second-type attack controls whose control orientation corresponds to a first target weapon orientation of the first target virtual weapon, based on the correspondence between the control orientation and the weapon orientation.

The update module 303 is configured to control to update the initial display mode of the first target attack control from the second-type attack controls to a first display effect style for display, and the first display effect style is different from the initial display mode.

The first control module 304 is configured to control, in response to a first control operation on the first target attack control from the second-type attack controls, the first target virtual weapon to perform a second-type attack on the target to be attacked.

In some embodiments, the apparatus further includes a second control module.

The second control module is configured to control the first target attack control from the second-type attack controls to display in the first display effect style, and to control other second-type attack controls to display in the second display effect style. The other second-type attack controls are the second-type attack controls in the second-type attack controls except for the first target attack control.

In some embodiments, the apparatus further includes a third control module.

The third control module is configured to control, in response to a second control operation on the first-type attack control, the first target virtual weapon to perform a first-type attack on the target to be attacked.

In some embodiments, the apparatus further includes an establishment module.

The establishment module is configured to establish a mapping relationship between the first-type attack control and the first target weapon orientation when the target to be attacked exists within the attack range of the first target virtual weapon in the virtual weapons.

The third control module includes a determination submodule and a control submodule.

The determination submodule is configured to determine, in response to the second control operation on the first-type attack control, the first target weapon orientation that has the mapping relationship with the first-type attack control.

The control submodule is configured to determine the first target virtual weapon configured at the first target weapon orientation, to control the first target virtual weapon to perform the first-type attack on the target to be attacked.

In some implementations, the first-type attack control includes multiple first control icon styles, and each first control icon style includes a virtual weapon identifier with a different displayed number.

The apparatus further includes a second determination module, a third determination module, and a second display module.

The second determination module is configured to determine a number of the first target virtual weapons.

The third determination module is configured to determine, based on correspondence between a number of virtual weapons and a displayed number, a target first control icon style from the multiple first control icon styles.

The second display module is configured to display the first-type attack control in the target first control icon style.

In some embodiments, the apparatus further includes a fourth determination module and a second control module.

The fourth determination module is configured to determine, in response to a third control operation starting from the first-type attack control and ending at the first target attack control from the second-type attack controls, a number of the first target virtual weapons.

The second control module is configured to control, in response to the number of the first target virtual weapons being one, the first target virtual weapon to perform the first-type attack and the second-type attack on the target to be attacked.

In some embodiments, the apparatus further includes a fifth determination module, a sixth determination module, and third control module.

The fifth determination module is configured to determine, in response to the number of the first target virtual weapons being not one, a designated first target attack control from the second-type attack controls, on which the third control operation is applied, among multiple first target attack controls from the second-type attack controls.

The sixth determination module is configured to determine, based on the correspondence between the control orientation and the weapon orientation, a designated first target virtual weapon whose weapon orientation corresponds to a designated target control orientation of the designated first target attack control from the second-type attack controls.

The third control module is configured to control the designated first target virtual weapon to perform the first-type attack and the second-type attack on the target to be attacked.

In some embodiments, the apparatus further includes a fourth control module.

The fourth control module is configured to control the first target virtual weapon to perform the first-type attack on the target to be attacked, and to control the designated first target virtual weapon to perform the second-type attack on the target to be attacked.

In some embodiments, an outer edge of the first-type attack control is provided with a viewpoint orientation identifier, and the apparatus further includes an obtaining module, a seventh determination module, and a fifth control module.

An obtaining module is configured to obtain a current viewpoint orientation to determine a second target virtual weapon within the current viewpoint orientation.

The seventh determination module is configured to determine, based on the correspondence between the control orientation and the weapon orientation, a second target attack control from the second-type attack controls whose control orientation corresponds to a second target weapon orientation of the second target virtual weapon.

The fifth control module is configured to control the viewpoint orientation identifier to point towards the second target attack control from the second-type attack controls.

In some embodiments, the virtual weapons include multiple weapon types, and a second control icon style of each second-type attack control corresponds to the weapon type of the virtual weapon corresponding thereto.

In some embodiments, the apparatus further includes a third display module.

The third display module is configured to display, in response to a third control operation on the first-type attack control, the attack range corresponding to each virtual weapon in the graphical user interface when no target to be attacked exists within the attack range of each virtual weapon.

As can be seen from the above, according to embodiments of the present disclosure, by using the first display module, a graphical user interface is displayed, which includes at least a portion of a virtual scene, and a target virtual vehicle, a first-type attack control, and a second-type attack control displayed in an initial display mode, that are located in the virtual scene. Virtual weapons are configured at different weapon orientations on the target virtual vehicle, and second-type attack controls are disposed at different control orientations relative to the first-type attack control. The control orientation of each second-type attack control and the weapon orientation of each virtual weapon are in correspondence. By using the first determination module, when there is a target to be attacked within an attack range of a first target virtual weapon in the virtual weapons, based on the correspondence between the control orientation and the weapon orientation, a first target attack control from the second-type attack controls is determined, whose control orientation corresponds to the first target weapon orientation of the first target virtual weapon. By using the update module, the initial display mode of the first target attack control is controlled to update to a first display effect style for display, with the first display effect style being different from the initial display mode. By using the first control module, in response to a first control operation on the first target attack control, the first target virtual weapon is controlled to perform a second-type attack on the target to be attacked. As a result, through the control operation on the second-type attack control from the user, it is possible to independently control one or more virtual weapons in the ship to perform an attack, thereby improving the simulated reality in the game when the user is playing.

The specific implementation of the above operations can be found in the previous embodiments, and will not be repeated here.

Embodiments of the present disclosure also provide a computer device, which can be a terminal or a server. The terminal can be a terminal device such as a smartphone, a tablet, a laptop, a touch screen, a game console, a personal computer (PC), a personal digital assistant (PDA), etc. As shown in FIG. 3, a schematic diagram of a structure of a computer device according to one or more embodiments of the present disclosure is provided. The computer device 1000 includes a processor 401 having one or more processing cores, a memory 402 having one or more computer-readable storage media, and a computer program stored on the memory 402 and executable on the processor. In some embodiments, the processor 401 is electrically connected to the memory 402. Those skilled in the art can understand that the structure of the computer device shown in the figure does not constitute a limitation on the computer device, and the computer device can include more or fewer components than shown in the figure, or combine certain components, or arrange different components.

The processor 401 is the control center of the computer device 1000, which connects various parts of the entire computer device 1000 through various interfaces and lines. The processor 401 is configured to execute various functions and process data of the computer device 1000 by running or loading software programs and/or modules stored in the memory 402, and calling data stored in the memory 402, thereby monitoring the overall performance of the computer device 1000.

In some embodiments, the processor 401 in the computer device 1000 loads instructions corresponding the processes of one or more application programs into the memory 402 according to the following steps, and the processor 401 runs the application programs stored in the memory 402 to achieve various functions.

The steps includes: displaying a graphical user interface, the graphical user interface includes at least a portion of a virtual scene, a target virtual vehicle, a first-type attack control, and second-type attack controls displayed in an initial display mode, which are located in the virtual scene, virtual weapons are configured at different weapon orientations on the target virtual vehicle, and the second-type attack controls are disposed at different control orientations relative to the first-type attack control, with the control orientation of each second-type attack control and the weapon orientation of each virtual weapon being in correspondence; when a target to be attacked exists within an attack range of a first target virtual weapon in the virtual weapons, determining a first target attack control from the second-type attack controls whose control orientation corresponds to a first target weapon orientation of the first target virtual weapon, based on the correspondence between the control orientation and the weapon orientation; controlling to update the initial display mode of the first target attack control from the second-type attack controls to a first display effect style for display, and the first display effect style is different from the initial display mode; and controlling, in response to a first control operation on the first target attack control from the second-type attack controls, the first target virtual weapon to perform a second-type attack on the target to be attacked.

Optionally, the method further includes: controlling, in response to a second control operation on the first-type attack control, the first target virtual weapon to perform a first-type attack on the target to be attacked.

Optionally, before controlling, in response to the second control operation on the first-type attack control, the first target virtual weapon to perform the first-type attack on the target to be attacked, the method further includes: in the case that the target to be attacked exists within the attack range of the first target virtual weapon in the virtual weapons, establishing a mapping relationship between the first-type attack control and the first target weapon orientation.

The step of controlling, in response to the second control operation on the first-type attack control, the first target virtual weapon to perform the first-type attack on the target to be attacked, includes: determining, in response to the second control operation on the first-type attack control, the first target weapon orientation that has the mapping relationship with the first-type attack control; and determining the first target virtual weapon configured at the first target weapon orientation, to control the first target virtual weapon to perform the first-type attack on the target to be attacked.

Optionally, the first-type attack control includes multiple first control icon styles, and each first control icon style includes a virtual weapon identifier with a different displayed number.

Before the step of controlling, in response to the second control operation on the first-type attack control, the first target virtual weapon to perform the first-type attack on the target to be attacked, the method further includes: determining a number of the first target virtual weapons; determining, based on correspondence between a number of virtual weapons and a displayed number, a target first control icon style from the multiple first control icon styles; and displaying the first-type attack control in the target first control icon style.

Optionally, the method further includes: determining, in response to a third control operation starting from the first-type attack control and ending at the first target attack control from the second-type attack controls, a number of the first target virtual weapons; and controlling, in response to the number of the first target virtual weapons being one, the first target virtual weapon to perform the first-type attack and the second-type attack on the target to be attacked.

Optionally, the method further includes: determining, in response to the number of the first target virtual weapons being not one, a designated first target attack control from the second-type attack controls, on which the third control operation is applied, among multiple first target attack controls from the second-type attack controls; determining, based on the correspondence between the control orientation and the weapon orientation, a designated first target virtual weapon whose weapon orientation corresponds to a designated target control orientation of the designated first target attack control from the second-type attack controls; and controlling the designated first target virtual weapon to perform the first-type attack and the second-type attack on the target to be attacked.

Optionally, the method further includes: controlling the first target virtual weapon to perform the first-type attack on the target to be attacked; and controlling the designated first target virtual weapon to perform the second-type attack on the target to be attacked.

Optionally, an outer edge of the first-type attack control is provided with a viewpoint orientation identifier, and the method further includes: obtaining a current viewpoint orientation to determine a second target virtual weapon within the current viewpoint orientation; determining, based on the correspondence between the control orientation and the weapon orientation, a second target attack control from the second-type attack controls whose control orientation corresponds to a second target weapon orientation of the second target virtual weapon; and controlling the viewpoint orientation identifier to point towards the second target attack control from the second-type attack controls.

Optionally, the virtual weapons include multiple weapon types, and a second control icon style of each second-type attack control corresponds to the weapon type of the virtual weapon corresponding thereto.

Optionally, the method further includes: in the case that no target to be attacked exists within the attack range of each virtual weapon, displaying, in response to a third control operation on the first-type attack control, the attack range corresponding to each virtual weapon in the graphical user interface.

The present disclosure is performed by displaying a graphical user interface, the graphical user interface includes at least a portion of a virtual scene, a target virtual vehicle, a first-type attack control, and second-type attack controls displayed in an initial display mode, which are located in the virtual scene, virtual weapons being configured at different weapon orientations on the target virtual vehicle, and the second-type attack controls being disposed at different control orientations relative to the first-type attack control, with the control orientation of each second-type attack control and the weapon orientation of each virtual weapon being in correspondence; when a target to be attacked exists within an attack range of a first target virtual weapon in the virtual weapons, determining a first target attack control from the second-type attack controls whose control orientation corresponds to a first target weapon orientation of the first target virtual weapon, based on the correspondence between the control orientation and the weapon orientation; controlling to update the initial display mode of the first target attack control from the second-type attack controls to a first display effect style for display, and the first display effect style being different from the initial display mode; and controlling, in response to a first control operation on the first target attack control from the second-type attack controls, the first target virtual weapon to perform a second-type attack on the target to be attacked. As a result, through the control operation on the second-type attack control from the user, it is possible to independently control one or more virtual weapons in the ship to perform an attack, thereby improving the simulated reality in the game when the user is playing.

The specific implementation of the above operations can be found in the previous embodiments, and will not be repeated here.

In some embodiments, as shown in FIG. 3, the computer device 1000 also includes a touch screen 403, a radio frequency (RF) circuit 404, an audio circuit 405, an input unit 406, and a power supply 407. In some embodiments, the processor 401 is electrically connected to the touch screen 403, the RF circuit 404, the audio circuit 405, the input unit 406, and the power supply 407. Those skilled in the art can understand that the structure of the computer device shown in FIG. 3 does not constitute a limitation on the computer device, and the computer device can include more or fewer components than shown in the figure, or combine certain components, or arrange different components.

The touch screen 403 can be used to display the graphical user interface and receive operation instructions generated based on the input by the user in the graphical user interface. The touch screen 403 can include a display panel and a touch panel. In some embodiments, the display panel can be used to display information input by the user or information provided to the user, as well as various graphical user interfaces of the computer device, which can be composed of graphics, texts, icons, videos, and any combination thereof. In some embodiments, the display panel can be configured using forms such as LCD (Liquid Crystal Display), OLED (Organic Light Emitting Diode), etc. The touch panel can be used to collect user touch operations on or near it (such as user operations using fingers, stylus, or any suitable objects or accessories on or near the touch panel), and generate corresponding operation instructions, which execute corresponding programs. In some embodiments, the touch panel can include two parts: a touch detection device and a touch controller. The touch detection device detects the orientation of the user's touch and detects the signal brought by the touch operation, and transmits the signal to the touch controller. The touch controller receives touch information from the touch detection device, converts it into touch point coordinates, and sends them to the processor 401. The touch controller can also receive commands from the processor 401 and execute them. The touch panel can cover the display panel. When the touch panel detects a touch operation on or near it, the touch panel transmits it to the processor 401 to determine the type of touch event. Then, the processor 401 provides corresponding visual output on the display panel based on the type of the touch event. In some embodiments, the touch panel and the display panel can be integrated into the touch screen 403 to achieve input and output functions. However, in some embodiments, the touch panel and the touch panel can be used as two independent components to achieve input and output functions. The touch screen 403 can also be used as part of the input unit 406 to implement input functions.

In some embodiments, the game application is executed by the processor 401 to generate a graphical user interface on touch screen 403. The virtual scene in the graphical user interface contains at least one skill control area, and the skill control area contains at least one skill control. The touch screen 403 is used to present the graphical user interface and receive operation instructions generated based on the input by the user in the graphical user interface.

The RF circuit 404 can be used for transmitting and receiving RF signals to establish wireless communication with network devices or other computer devices through wireless communication, and to transmit and receive signals between network devices or other computer devices.

The audio circuit 405 can be used to provide an audio interface between users and computer devices through speakers and microphones. The audio circuit 405 can convert the received audio data into electrical signals, transmit them to the speaker, and convert them into sound signals for output. On the other hand, the microphone converts the collected sound signal into an electrical signal, which is received by the audio circuit 405 and converted into audio data. The audio data is then output to the processor 401 for processing and sent to another computer device through the RF circuit 404, or the audio data is output to the memory 402 for further processing. The audio circuit 405 can also include an earphone jack to provide communication between peripheral headphones and the computer devices.

The input unit 406 can be used to receive input number and character information, or user feature information (such as fingerprints, irises, facial information, etc.), as well as generate keyboard, mouse, joystick, optical, or trackball signal inputs related to user settings and function control.

The power supply 407 is used to supply power to various components of computer device 1000. Optionally, the power supply 407 can be logically connected to the processor 401 through a power management system, thereby achieving functions such as managing charging, discharging, and power consumption through the power management system. The power supply 407 can also include one or more DC or AC power sources, a recharging system, a power fault detection circuit, a power converter or inverter, a power status indicator, and any other components.

Although not shown in FIG. 3, the computer device 1000 can also include cameras, sensors, wireless fidelity modules, Bluetooth modules, etc., which will not be repeated here.

In the above embodiments, the description of each embodiment has its own emphasis. For the parts that are not detailed in one embodiment, reference can be made to the relevant descriptions in other embodiments.

As can be seen from the above, the computer device provided in the above embodiments, is configured for displaying a graphical user interface, the graphical user interface includes at least a portion of a virtual scene, a target virtual vehicle, a first-type attack control, and second-type attack controls displayed in an initial display mode, which are located in the virtual scene, virtual weapons are configured at different weapon orientations on the target virtual vehicle, and the second-type attack controls are disposed at different control orientations relative to the first-type attack control, with the control orientation of each second-type attack control and the weapon orientation of each virtual weapon being in correspondence; when a target to be attacked exists within an attack range of a first target virtual weapon in the virtual weapons, determining a first target attack control from the second-type attack controls whose control orientation corresponds to a first target weapon orientation of the first target virtual weapon, based on the correspondence between the control orientation and the weapon orientation; controlling to update the initial display mode of the first target attack control from the second-type attack controls to a first display effect style for display, and the first display effect style is different from the initial display mode; and controlling, in response to a first control operation on the first target attack control from the second-type attack controls, the first target virtual weapon to perform a second-type attack on the target to be attacked. As a result, through the control operation on the second-type attack control from the user, it is possible to independently control one or more virtual weapons in the ship to perform an attack, thereby improving the simulated reality in the game when the user is playing.

Those of ordinary skill in the art can understand that all or part of the steps in the various methods of the above embodiments can be completed through instructions, or by controlling relevant hardware through instructions. The instructions can be stored in a computer-readable storage medium and loaded and executed by a processor.

Therefore, embodiments of the present disclosure provide a computer-readable storage medium having computer programs stored thereon. The computer programs can be loaded by a processor to execute the steps in the attack methods for the virtual weapon provided in embodiments of the present disclosure. For example, the computer program can perform the following steps.

The steps includes: displaying a graphical user interface, the graphical user interface includes at least a portion of a virtual scene, a target virtual vehicle, a first-type attack control, and second-type attack controls displayed in an initial display mode, which are located in the virtual scene, virtual weapons are configured at different weapon orientations on the target virtual vehicle, and the second-type attack controls are disposed at different control orientations relative to the first-type attack control, with the control orientation of each second-type attack control and the weapon orientation of each virtual weapon being in correspondence; when a target to be attacked exists within an attack range of a first target virtual weapon in the virtual weapons, determining a first target attack control from the second-type attack controls whose control orientation corresponds to a first target weapon orientation of the first target virtual weapon, based on the correspondence between the control orientation and the weapon orientation; controlling to update the initial display mode of the first target attack control from the second-type attack controls to a first display effect style for display, and the first display effect style is different from the initial display mode; and controlling, in response to a first control operation on the first target attack control from the second-type attack controls, the first target virtual weapon to perform a second-type attack on the target to be attacked.

Optionally, the method further includes: controlling, in response to a second control operation on the first-type attack control, the first target virtual weapon to perform a first-type attack on the target to be attacked.

Optionally, before controlling, in response to the second control operation on the first-type attack control, the first target virtual weapon to perform the first-type attack on the target to be attacked, the method further includes: in the case that the target to be attacked exists within the attack range of the first target virtual weapon in the virtual weapons, establishing a mapping relationship between the first-type attack control and the first target weapon orientation.

The step of controlling, in response to the second control operation on the first-type attack control, the first target virtual weapon to perform the first-type attack on the target to be attacked, includes: determining, in response to the second control operation on the first-type attack control, the first target weapon orientation that has the mapping relationship with the first-type attack control; and determining the first target virtual weapon configured at the first target weapon orientation, to control the first target virtual weapon to perform the first-type attack on the target to be attacked.

Optionally, the first-type attack control includes multiple first control icon styles, and each first control icon style includes a virtual weapon identifier with a different displayed number.

Before the step of controlling, in response to the second control operation on the first-type attack control, the first target virtual weapon to perform the first-type attack on the target to be attacked, the method further includes: determining a number of the first target virtual weapons; determining, based on correspondence between a number of virtual weapons and a displayed number, a target first control icon style from the multiple first control icon styles; and displaying the first-type attack control in the target first control icon style.

Optionally, the method further includes: determining, in response to a third control operation starting from the first-type attack control and ending at the first target attack control from the second-type attack controls, a number of the first target virtual weapons; and controlling, in response to the number of the first target virtual weapons being one, the first target virtual weapon to perform the first-type attack and the second-type attack on the target to be attacked.

Optionally, the method further includes: determining, in response to the number of the first target virtual weapons being not one, a designated first target attack control from the second-type attack controls, on which the third control operation is applied, among multiple first target attack controls from the second-type attack controls; determining, based on the correspondence between the control orientation and the weapon orientation, a designated first target virtual weapon whose weapon orientation corresponds to a designated target control orientation of the designated first target attack control from the second-type attack controls; and controlling the designated first target virtual weapon to perform the first-type attack and the second-type attack on the target to be attacked.

Optionally, the method further includes: controlling the first target virtual weapon to perform the first-type attack on the target to be attacked; and controlling the designated first target virtual weapon to perform the second-type attack on the target to be attacked.

Optionally, an outer edge of the first-type attack control is provided with a viewpoint orientation identifier, and the method further includes: obtaining a current viewpoint orientation to determine a second target virtual weapon within the current viewpoint orientation; determining, based on the correspondence between the control orientation and the weapon orientation, a second target attack control from the second-type attack controls whose control orientation corresponds to a second target weapon orientation of the second target virtual weapon; and controlling the viewpoint orientation identifier to point towards the second target attack control from the second-type attack controls.

Optionally, the virtual weapons include multiple weapon types, and a second control icon style of each second-type attack control corresponds to the weapon type of the virtual weapon corresponding thereto.

Optionally, the method further includes: in the case that no target to be attacked exists within the attack range of each virtual weapon, displaying, in response to a third control operation on the first-type attack control, the attack range corresponding to each virtual weapon in the graphical user interface.

The present disclosure is performed by displaying a graphical user interface, the graphical user interface includes at least a portion of a virtual scene, a target virtual vehicle, a first-type attack control, and second-type attack controls displayed in an initial display mode, which are located in the virtual scene, virtual weapons being configured at different weapon orientations on the target virtual vehicle, and the second-type attack controls being disposed at different control orientations relative to the first-type attack control, with the control orientation of each second-type attack control and the weapon orientation of each virtual weapon being in correspondence; when a target to be attacked exists within an attack range of a first target virtual weapon in the virtual weapons, determining a first target attack control from the second-type attack controls whose control orientation corresponds to a first target weapon orientation of the first target virtual weapon, based on the correspondence between the control orientation and the weapon orientation; controlling to update the initial display mode of the first target attack control from the second-type attack controls to a first display effect style for display, and the first display effect style being different from the initial display mode; and controlling, in response to a first control operation on the first target attack control from the second-type attack controls, the first target virtual weapon to perform a second-type attack on the target to be attacked. As a result, through the control operation on the second-type attack control from the user, it is possible to independently control one or more virtual weapons in the ship to perform an attack, thereby improving the simulated reality in the game when the user is playing.

The specific implementation of the above operations can be found in the previous embodiments, and will not be repeated here.

In some embodiments, the storage medium can include: read only memory (ROM), random access memory (RAM), magnetic disk, or optical disk, etc.

Due to the computer programs stored in the storage medium being capable of executing the steps of any of the attack methods for the virtual weapon provided in embodiments of the present disclosure, the beneficial effects that can be achieved by any of the attack methods for the virtual weapon provided in embodiments of the present disclosure can be achieved. Reference can be made to the previous embodiments for details, which will not be repeated here.

A detailed introduction to the attack method for the virtual weapon, the attack apparatus for the virtual weapon, the storage medium, and the computer device provided in embodiments of the present disclosure is made above. Specific embodiments are used to explain the principles and implementations of the present disclosure. The above embodiments are only used to help understand the method and core ideas of the present disclosure. Meanwhile, for those skilled in the art, there will be changes in the specific implementations and the application scope based on the ideas of the present disclosure. In conclusion, the contents of the specification should not be understood as limiting the present disclosure.

1. An attack method for a virtual weapon, comprising:
displaying a graphical user interface, wherein the graphical user interface comprises at least a portion of a virtual scene, a target virtual vehicle, a first-type attack control, and second-type attack controls displayed in an initial display mode, which are located in the virtual scene, virtual weapons are configured at different weapon orientations on the target virtual vehicle, and the second-type attack controls are disposed at different control orientations relative to the first-type attack control, with the control orientation of each second-type attack control and the weapon orientation of each virtual weapon being in correspondence;
in the case that a target to be attacked exists within an attack range of a first target virtual weapon in the virtual weapons, determining, based on the correspondence between the control orientation and the weapon orientation, a first target attack control from the second-type attack controls whose control orientation corresponds to a first target weapon orientation of the first target virtual weapon;
controlling to update the initial display mode of the first target attack control to a first display effect style for display, wherein the first display effect style is different from the initial display mode; and
controlling, in response to a first control operation on the first target attack control to a first target virtual weapon to perform a second-type attack on the target to be attacked.

2. The attack method for the virtual weapon according to claim 1, further comprising:
controlling, in response to a second control operation on the first-type attack control, the first target virtual weapon to perform a first-type attack on the target to be attacked.

3. The attack method for the virtual weapon according to claim 2, further comprising:
in the case that the target to be attacked exists within the attack range of the first target virtual weapon in the virtual weapons, establishing, in response to the second control operation on the first-type attack control, a mapping relationship between the first-type attack control and the first target weapon orientation before controlling the first target virtual weapon to perform the first-type attack on the target to be attacked; and
wherein controlling the first target virtual weapon to perform the first-type attack on the target to be attacked, comprises:
determining, in response to the second control operation on the first-type attack control, the first target weapon orientation that has the mapping relationship with the first-type attack control; and
determining the first target virtual weapon configured at the first target weapon orientation, to control the first target virtual weapon to perform the first-type attack on the target to be attacked.

4. The attack method for the virtual weapon according to claim 2, wherein the first-type attack control comprises multiple first control icon styles, each first control icon style comprises a virtual weapon identifier with a different displayed number, and
the method further comprises:
determining, in response to the second control operation on the first-type attack control, a number of the first target virtual weapons before controlling the first target virtual weapon to perform the first-type attack on the target to be attacked;
determining, based on correspondence between a number of virtual weapons and a displayed number, a target first control icon style from the multiple first control icon styles; and
displaying the first-type attack control in the target first control icon style.

5. The attack method for the virtual weapon according to claim 2, further comprising:
determining, in response to a third control operation starting from the first-type attack control and ending at the first target attack control, a number of the first target virtual weapons; and
controlling, in response to the number of the first target virtual weapons being one, the first target virtual weapon to perform the first-type attack and the second-type attack on the target to be attacked.

6. The attack method for the virtual weapon according to claim 5, further comprising:
determining, in response to the number of the first target virtual weapons being not one, a designated first target attack control, on which the third control operation is applied, among multiple first target attack controls from the second-type attack controls;
determining, based on the correspondence between the control orientation and the weapon orientation, a designated first target virtual weapon whose weapon orientation corresponds to a designated target control orientation of the designated first target attack control, and
controlling the designated first target virtual weapon to perform the first-type attack and the second-type attack on the target to be attacked.

7. The attack method for the virtual weapon according to claim 6, further comprising:
controlling the first target virtual weapon to perform the first-type attack on the target to be attacked; and
controlling the designated first target virtual weapon to perform the second-type attack on the target to be attacked.

8. The attack method for the virtual weapon according to claim 1, wherein an outer edge of the first-type attack control is provided with a viewpoint orientation identifier, and the method further comprises:
obtaining a current viewpoint orientation to determine a second target virtual weapon within the current viewpoint orientation;
determining, based on the correspondence between the control orientation and the weapon orientation, a second target attack control from the second-type attack controls whose control orientation corresponds to a second target weapon orientation of the second target virtual weapon; and
controlling the viewpoint orientation identifier to point towards the second target attack control.

9. The attack method for the virtual weapon according to claim 1, wherein the virtual weapons comprise multiple weapon types, and a second control icon style of each second-type attack control corresponds to the weapon type of the virtual weapon corresponding thereto.

10. The attack method for the virtual weapon according to claim 1, further comprising:
in the case that no target to be attacked exists within the attack range of each virtual weapon, displaying, in response to a third control operation on the first-type attack control, the attack range corresponding to each virtual weapon in the graphical user interface.

11. (canceled)

12. (canceled)

13. A computer device, comprising:
a memory;
a processor; and
a computer program stored on the memory and executable on the processor, wherein the processor is configured to:
display a graphical user interface, wherein the graphical user interface comprises at least a portion of a virtual scene, a target virtual vehicle, a first-type attack control, and second-type attack controls displayed in an initial display mode, which are located in the virtual scene, virtual weapons are configured at different weapon orientations on the target virtual vehicle, and the second-type attack controls are disposed at different control orientations relative to the first-type attack control, with the control orientation of each second-type attack control and the weapon orientation of each virtual weapon being in correspondence;
in the case that a target to be attacked exists within an attack range of a first target virtual weapon in the virtual weapons, determine, based on the correspondence between the control orientation and the weapon orientation, a first target attack control from the second-type attack controls whose control orientation corresponds to a first target weapon orientation of the first target virtual weapon;
control to update the initial display mode of the first target attack control to a first display effect style for display, wherein the first display effect style is different from the initial display mode; and
control, in response to a first control operation on the first target attack control, the first target virtual weapon to perform a second-type attack on the target to be attacked.

14. The computer device according to claim 13, wherein the processor is further configured to:
control, in response to a second control operation on the first-type attack control, the first target virtual weapon to perform a first-type attack on the target to be attacked.

15. The computer device according to claim 14, wherein the processor is further configured to:
in the case that the target to be attacked exists within the attack range of the first target virtual weapon in the virtual weapons, establish, in response to the second control operation on the first-type attack control, a mapping relationship between the first-type attack control and the first target weapon orientation before controlling the first target virtual weapon to perform the first-type attack on the target to be attacked; and
wherein the processor is further configured to:
determine, in response to the second control operation on the first-type attack control, the first target weapon orientation that has the mapping relationship with the first-type attack control; and
determine the first target virtual weapon configured at the first target weapon orientation, to control the first target virtual weapon to perform the first-type attack on the target to be attacked.

16. The computer device according to claim 14, wherein the first-type attack control comprises multiple first control icon styles, each first control icon style comprises a virtual weapon identifier with a different displayed number, and the processor is further configured to:
determine, in response to the second control operation on the first-type attack control, a number of the first target virtual weapons before controlling the first target virtual weapon to perform the first-type attack on the target to be attacked;
determine, based on correspondence between a number of virtual weapons and a displayed number, a target first control icon style from the multiple first control icon styles; and
display the first-type attack control in the target first control icon style.

17. The computer device according to claim 14, wherein the processor is further configured to:
determine, in response to a third control operation starting from the first-type attack control and ending at the first target attack control, a number of the first target virtual weapons; and
control, in response to the number of the first target virtual weapons being one, the first target virtual weapon to perform the first-type attack and the second-type attack on the target to be attacked.

18. The computer device according to claim 17, wherein the processor is further configured to:
determine, in response to the number of the first target virtual weapons being not one, a designated first target attack control, on which the third control operation is applied, among multiple first target attack controls from the second-type attack controls;
determine, based on the correspondence between the control orientation and the weapon orientation, a designated first target virtual weapon whose weapon orientation corresponds to a designated target control orientation of the designated first target attack control; and
control the designated first target virtual weapon to perform the first-type attack and the second-type attack on the target to be attacked.

19. The computer device according to claim 18, wherein the processor is further configured to:
control the first target virtual weapon to perform the first-type attack on the target to be attacked; and
control the designated first target virtual weapon to perform the second-type attack on the target to be attacked.

20. The computer device according to claim 13, wherein an outer edge of the first-type attack control is provided with a viewpoint orientation identifier, and the processor is further configured to:
obtain a current viewpoint orientation to determine a second target virtual weapon within the current viewpoint orientation;
determine, based on the correspondence between the control orientation and the weapon orientation, a second target attack control from the second-type attack controls whose control orientation corresponds to a second target weapon orientation of the second target virtual weapon; and
control the viewpoint orientation identifier to point towards the second target attack control.

21. The computer device according to claim 13, wherein the virtual weapons comprise multiple weapon types, and a second control icon style of each second-type attack control corresponds to the weapon type of the virtual weapon corresponding thereto.

22. The computer device according to claim 13, wherein the processor is further configured to:
in the case that no target to be attacked exists within the attack range of each virtual weapon, display, in response to a third control operation on the first-type attack control, the attack range corresponding to each virtual weapon in the graphical user interface.
